(19) United States
(12) Patent Application Publication
(10) Pub. No.: US 2015/0121530 A1
(43) Pub. Date: Apr. 30, 2015

(54) System and Method for Sharing Files Between a Removable Device and a Target System

(71) Applicant: Lexmark International, Inc., Lexington, KY (US)

(72) Inventor: Gary Lee Noe, Lexington, KY (US)

(73) Assignee: Lexmark International, Inc., Lexington, KY (US)

(21) Appl. No.: 14/067,092

(22) Filed: Oct. 30, 2013

(51) Int. Cl. G06F 17/30; G06F 21/56

(52) U.S. Cl. CPC G06F 17/30076; G06F 17/30218; G06F 21/56
USPC 726/24; 707/824

(57) ABSTRACT

A method for sharing one or more files from a removable medium to a target computer includes sending a request for an application for converting the one or more files to a format compatible for use in the target computer; using the application, converting the files into the compatible format; emulating a file system, the emulated file system corresponding to the removable medium; storing the converted files in the emulated file system; and providing the target computer access to the converted files through the emulated file system.

### FIELD OF THE INVENTION

The present invention relates to sharing files between a removable device and a target system. More particularly, it relates to systems and methods of sharing conditioned files between a removable device and a target system for immediate use thereby.

### BACKGROUND

Removable memory devices such as USB flash drives, memory cards, and portable hard drives are typically used to hold and share files directly from the removable memory device to one or more target computers that the removable memory device connects to. However, incompatibility between the stored files and applications that run in a target computer may occur such that the target computer may not have the capabilities or applications to open the stored files, rendering the files useless for users of the target computer.

Direct file sharing between the two devices may also provide a means for computer viruses to spread from one device to another. If a target computer the removable memory device is connected to lacks adequate virus protection, the target computer runs the risks of becoming infected with malicious software that removable device may carry. Alternately, the removable device may also become compromised if the target computer holds one or more computer viruses.

Accordingly, a need exists in the art to secure removable devices and target computers that allows the two devices to share files without compromising the security of either device. What is also needed is a method of conditioning files stored in a removable device to become compatible with the target device such that the files are immediately useable by the target computer. Additional benefits and alternatives are also sought when devising solutions.

### SUMMARY

The above-mentioned and other problems are solved by systems and methods for sharing one or more files from a removable medium to a target computer. In a representative embodiment, the method may include accessing an application for converting files stored in the removable medium to a format compatible for use in the target computer. Using the application, the files are then converted into a compatible format. In an alternative example embodiment, the files may also be scanned and cleaned from virus using an application requested and retrieved from a device connected to a conditioning device that facilitates the conditioning and sharing process of the files from the removable medium to the target computer. The file system in the removable medium may also be emulated in the conditioning device to correspond to the removable medium. The method further includes storing the converted and/or cleaned files in the emulated file system and providing the target computer access to the converted files through the emulated file system.

In an alternative example embodiment, a computing device for conditioning files stored in a removable storage device into a format suitable for immediate use by a target computer upon the removable storage device connecting with the target computer is provided. The computing device may include a peripheral interface for communicatively connecting to the target computer, a file system emulated to appear as the removable storage device to the target computer, and a controller operative to access an antivirus application from a remote system communicatively connected with the computing device to scan the one or more files in the removable storage device. The controller may also store the scanned one or more files in the file system, and allow the target computer to access the scanned one or more files through the emulated file system.

In another alternative example embodiment, a filtering device communicatively connected to a removable media device is provided. The filtering device may include a non-transitory computer-readable storage medium containing computer executable instructions to receive a request from a host computing device to access one or more files stored in the removable media device. The filtering device may also set up one or more parameters to be used for reformatting the one or more files stored in the removable media device to a format for immediate use by the host computing device upon connecting to the removable media device, reformat the one or more files using the one or more parameters, emulate a file system to correspond to the removable media device, store the reformatted one or more files in the emulated file system, and allow the host computing device to access the reformatted one or more files through the emulated file system.

These and other example embodiments are set forth in the description below. Their advantages and features will become readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view of a system in accordance with the present disclosure showing a connection between a removable device, a target computer and a conditioning device.

FIG. 2 shows a diagrammatic view of a conditioning device communicatively connected with a removable device and a target computer.

FIG. 3 shows an example system including an imaging device embedded with a conditioning device and communicatively connected with a removable device and a target computer.

FIG. 4 shows an example method of conditioning files by converting incompatible files to a compatible format for immediate use by a target computer.

FIG. 5 shows an example method of conditioning files by scanning, cleaning, and/or repairing files prior to sharing to a target computer.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that process, electrical, and mechanical changes, etc., may be made without departing from the scope of the invention. The following detailed description, therefore, is not to be taken in a limiting sense and the scope of the invention is defined only by the appended claims and their equivalents. In accordance with the features of the invention, systems and methods for conditioning files prior to sharing the files from a removable device to a target computer are provided that reformat incompatible files to a compatible format for immediate use by the target computer; and scans, repairs and cleans corrupted and/or infected files from malicious software for safely sharing the files between the two devices.

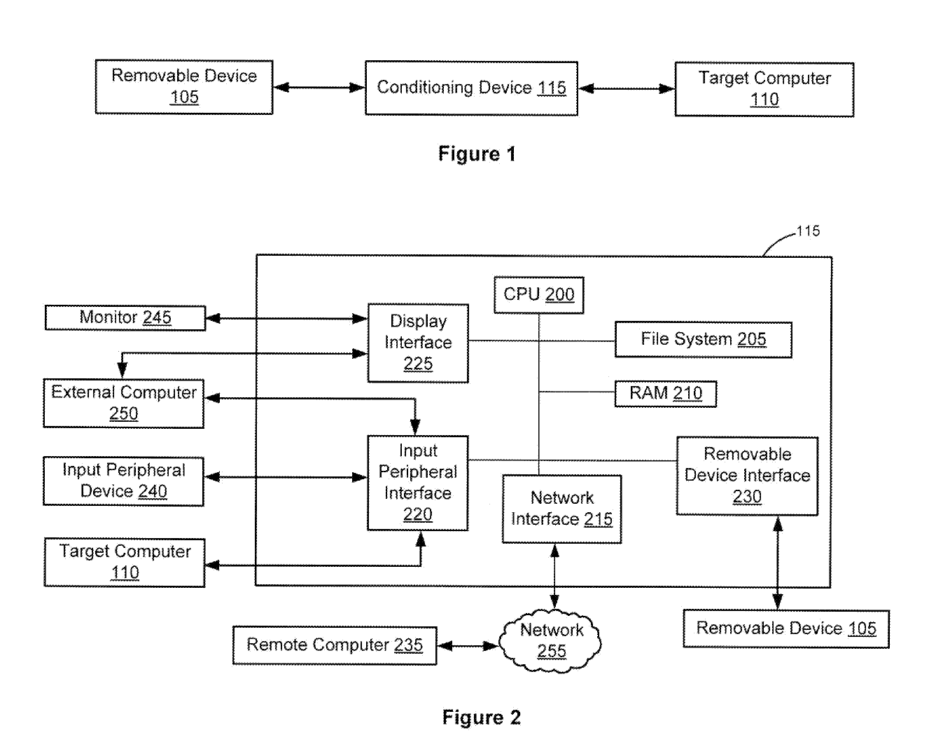

With reference to FIG. 1, there is shown a system including a removable device 105, a target computer 110, and a conditioning device 115. Removable device 105 may be any removable or portable computer-readable storage medium device for storing one or more files and includes an interface that allows removable device 105 to communicatively connect to target computer 110 for sharing the one or more files from removable device 105 to target computer 110. Removable device 105 is also capable of storing files from the target computer 110 to a data storage component (not shown) within removable device 105. For example, removable device 105 may be a USB flash drive, a removable flash memory card, an external hard drive, and other types of removable storage devices as will be known in the art.

Target computer 110 is a computing device having an interface component adapted to connect to removable device 105. For example, target computer 110 may be a laptop computer, a personal computer, or workstation computer. Target computer 110 may be installed with one or more applications that can be requested by conditioning device 115 to perform one or more needed functions for conditioning files stored in removable device 105 for immediate use by target computer 110.

Conditioning device 115 is a computing device having an interface for connecting removable device 105 to target computer 110. Conditioning device 115 allows removable device 105 to safely share files to target computer 110 by conditioning the one or more files stored in removable device 105 prior to sharing the files to target computer 110. Conditioning the stored files includes requesting and retrieving an application to condition the files by scanning, cleaning and repairing the files stored in removable device 105. Conditioning the files may also include reformatting or converting the stored files from an incompatible format into a format that is compatible for immediate use by target computer 110. Conditioning device 115 may also provide target computer 110 access to the conditioned files without target computer 110 directly accessing removable device 105 to avoid transmission of malicious software between the two devices. Conditioning device 115 may act as a filtering device that ensures safe and compatible sharing of files between removable device 105 and target computer 110.

With reference to FIG. 2, there is shown a block diagram of conditioning device 115 communicatively connected with removable device 105 and target computer 110. Conditioning device 115 includes a central processing unit (CPU) 200, a file system 205, a random-access memory (RAM) 210, a network interface 215, an input peripheral interface 220, a display interface 225, and a removable device interface 230. Conditioning device 115 may also be communicatively connected with a remote computer 235 through a network 255 connected to conditioning device 115 via network interface 215. Conditioning device 115 may also connect to an input peripheral device 240 through input peripheral interface 220, a display monitor 245 through display interface 225, and to an external computer system 250 having input/output capabilities through display interface 225 and input peripheral interface 220. External computer system 250 provides the user interface and input capabilities to conditioning device 115 for setting up operational parameters, as will be discussed in greater detail below.

CPU 200 is an internal processor or conditioning device controller configured to run one or more computer instructions for carrying out operations of conditioning device 115. CPU 200 may be communicatively connected to file system 205 and RAM 210. File system 205 may be a computer-readable non-transitory storage medium for storing one or more files which may be files retrieved from at least one of removable device 105 and target computer 110. RAM 210 may be configured to store the computer instructions performed in conditioning device 115.

During use, conditioning device 115 may operate in a networked environment using logical connections to one or more other computing configurations, such as remote computer 235 through network 255. Remote computer 235 may be a personal computer, a server, a router, a network PC, a peer device or other common network node, and typically includes many or all of the elements described above relative to the target computer 110. The logical connections between conditioning device 115 and remote computer 235 may include a local area network (LAN) (not shown) and/or a wide area network (WAN) (not shown). Such networking environments are commonplace in offices with enterprise-wide computer networks, intranets and the Internet, but may also be adapted for use in a mobile environment at multiple fixed or changing locations, as will be known in the art.

When used in a LAN networking environment, conditioning device 115 is connected to the LAN through network interface 215. When used in a WAN networking environment, conditioning device 115 typically includes a modem (not shown), T1 line, satellite or other means for establishing communications over the WAN, such as the Internet. In a networked environment, program modules depicted relative to the conditioning device 115, or portions thereof, may be stored in the local or remote memory storage devices and may be linked to various processing devices for performing certain tasks. It will be appreciated that the network connections shown are illustrative and other means of establishing a communications link between the devices may be used. Moreover, those skilled in the art will appreciate that the invention may be practiced with other computer system configurations, including host devices in the form of hand-held devices, multi-processor systems, micro-processor-based or programmable consumer electronics, network PCs, minicomputers, computer clusters, main frame computers, and the like. Using network interface 215, conditioning device 115 may also receive a connection request from target computer 110, and facilitate connection with target computer 110 using one or more connection means as will be known in the art.

Conditioning device 115 may also include a basic input/output system containing basic routines that help transfer information between elements within conditioning device 115 and between conditioning device 115 and other connected devices. The computer instructions used by conditioning device 115 to perform one or more functions may be stored in a read-only memory (ROM). The basic input/output system may include input peripheral interface 220 and display interface 225. Input peripheral interface 220 allows a user to enter commands and information through input peripheral device 240 that can be used by conditioning device 115 to send a request and retrieve an application for use in converting files stored in removable device 115 or for activating an antivirus application for scanning and cleaning files stored in removable device 115. The basic input/out system may also include a monitor 245 or any type of display device that connects to and receives data for displaying from conditioning device 115 through display interface 225. Display interface 225 may be a video adapter, VGA connector, among others. Display interface 225 and input peripheral interface 220 may also be configured to connect conditioning device 115 to external computer system 250 that may be used by conditioning device 115 to set up one or more parameters for conditioning the files prior to sharing.

Conditioning device 115 may operate in two modes—Configuration and File Access modes. In the Configuration mode, operational parameters are set up in preparation for conditioning the files such as, reformatting, repairing and cleaning the files from malicious software. Operational parameters may include one or more applications to be retrieved from a computing device connected to conditioning device 115, and setting up operational parameters may include an instruction to access an application for reformatting, cleaning or repairing the files. In the Configuration mode, user preferences relating to the one or more files to be scanned by conditioning device 115 may also be received from a user using input and output devices connected to conditioning device 115. In the File Access mode, target computer 110 connects to conditioning device 115 via USB or through a network. Conditioning device 115 then emulates a drive to correspond to removable device 105, and stores a copy of the conditioned files to the emulated drive. Target computer 110 will be configured to access the emulated removable device in file system 205 containing copies of the conditioned files instead of accessing removable device 105 to retrieve the conditioned files.

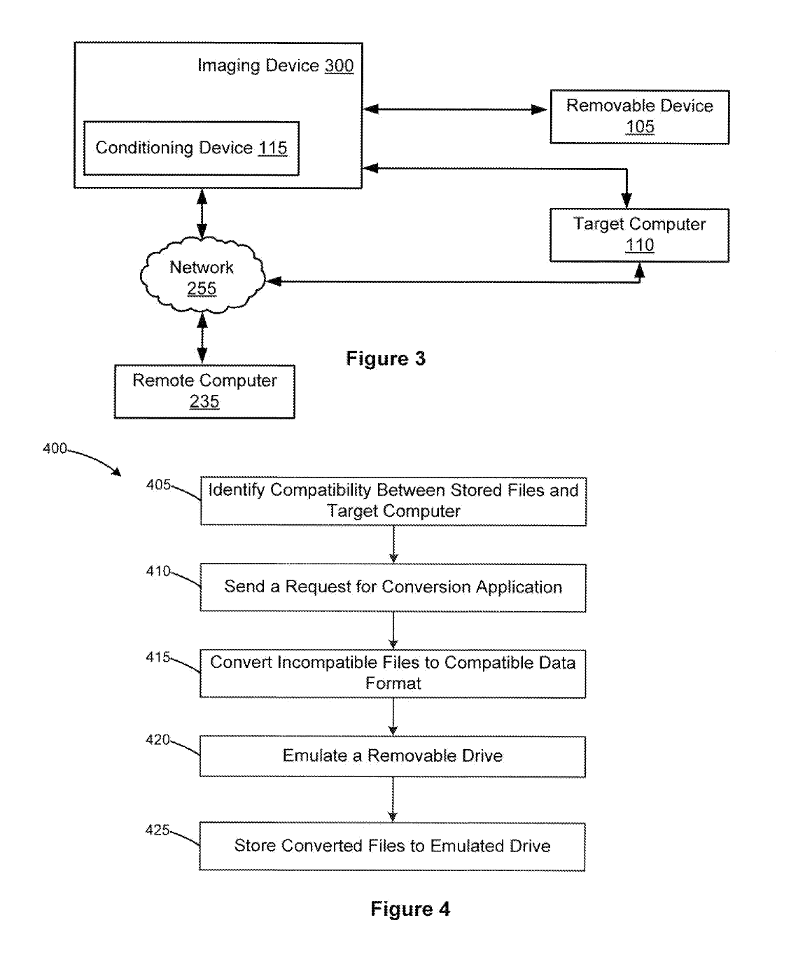

Conditioning device 115 can be a stand-alone device connected to removable device 105 and target computer 110 such as the system shown in FIG. 1, or be integrated to a standard computer peripheral such as, for example, an imaging device. FIG. 3 shows an example system including an imaging device 300 embedded with conditioning device 115 for conditioning one or more files from at least one of removable device 105 and target computer 110 prior to processing by imaging device 300, or prior to transferring the files among the devices in the system. Hardware and firmware elements of conditioning device 115 may be added to imaging device 300. Imaging device 300 may be any device capable of printing or producing a hard copy corresponding to a data file or document stored in electronic form, such as a laser, inkjet or dot matrix printer or multi-function printing device that has the capability of performing other functions, such a faxing, e-mailing, scanning and/or copying, in addition to printing. The data file or electronic document to be printed by imaging device 300 may be received from at least one of target computer 110 and removable device 105.

Using imaging device 300 embedded with conditioning device 115 as an illustrative embodiment, imaging device 300 may include a display means such as, for example, an LCD touch screen or other means for displaying output in imaging device 300 that will be used by conditioning device 115 to display one or more output for use in conditioning files. Imaging device 300 may also include communication interfaces configured to connect imaging device 300 with other devices, such as, for example remote computer 235 through network 255 and target computer 110 via a USB interface or any other connection means as will be known in the art. A connection between imaging device 300 and remote computer 235 through network 255 allows conditioning device 115 in imaging device 300 to retrieve one or more applications from remote computer 235 for use in conditioning files. In an alternative example embodiment, conditioning device 115 may also retrieve applications from target computer 110 connected to imaging device 300, or any other computing device connected to imaging device 300.

Removable device interface such as, for example, USB and card reader interfaces, is also included in imaging device 300 to allow imaging device 300 to be communicatively connected with removable device 105. In one example embodiment, an application is downloaded to imaging device 300 to enable a conditioning functionality of conditioning device 115 in imaging device 300 that allows imaging device 300 to condition files stored in either or both target computer 110 and removable device 105 that may be processed by imaging device 300 either for printing, or for transferring the files from removable device 105 to target computer 110 and vice-versa.

FIG. 4 is a flowchart showing an example method 400 of conditioning files stored in removable device 105 by reformatting files identified to be incompatible with target computer 110 to a compatible format. Compatible files are referred to herein as files saved in a format that can be immediately used by target computer 110 upon connecting with removable device 105. Files that are in a format that target computer 110 is not able to use for various reasons such as, for example, target computer 110 is not installed with the appropriate application that can open and process the file, will be referred to herein as incompatible files. Other files considered incompatible may include files that are not natively supported by installed applications in target computer 110. For example, a file stored in removable device 105 that is in a data format that is generated by a newer version of an application than the installed application in target computer 110, thereby disallowing target computer 110 to open the file with the installed application, may be considered an incompatible tile. Other forms of incompatible and compatible files will be known by skilled artisans.

Method 400 may be performed by one or more computer instructions stored in conditioning device 115 in example systems shown in FIGS. 1-3. It will be appreciated that the actions described and, shown in method 400 may be carried out or performed in any suitable order.

At 405, compatibility between the files stored in removable drive 105 and target computer 110 is identified. Identifying compatibility includes identifying the data formats of the stored files and determining if target computer 110 is installed with at least one application that is capable of opening the files based on the data formats and the types and versions of installed applications in target computer 110.

One or more parameters may then be set up by conditioning device 115 to be used for reformatting the one or more files. At 410 if at least one stored file is identified to be incompatible with target computer 110, a request for an application to convert the file to a format compatible with target computer 110 is sent from conditioning device 115 to remote computer 235 through network 255. In an alternative example embodiment, conditioning device 115 may send the request for a conversion application to target computer 110. Target computer 110 may be queried to determine if target computer 110 contains an application for converting the files before sending a request for the application to remote computer 235.

Retrieving a conversion application may include a user manually choosing the application for converting the files to a compatible format through the use of input peripheral device 240 and monitor 245 connected to conditioning device 115, or through input and output means of imaging device 300 if conditioning device 115 is embedded in imaging device 300. Retrieving the conversion application may also include retrieving the application using external computer system 250 directly connected with conditioning device 115, or through imaging device 300.

At 415, the stored one or more files are then converted to a data format that is compatible with target computer 110 using the conversion application retrieved at 415. In one example embodiment, the converting of the files using the requested application may be performed while the application is running on target computer 110, on remote computer 235, or on any computing device from which the application was requested.

At 420, a removable drive is emulated by conditioning device 115 to correspond to removable device 105. Emulating a drive duplicates or emulates functions of storage drive of removable device 105 right in conditioning device 115 such that the emulated drive closely resembles the behavior of removable device 105.

At 425, the converted files are then stored in the emulated drive. Target computer 110 is given access to the converted file through the emulated drive in conditioning device 115 instead of directly accessing removable device 105 to prevent contamination of either or both removable device 105 and target computer 110 if at least one of the devices contains malicious software. Accessing the emulated drive to retrieve the conditioned files also allows target computer 110 to access files that are determined to be compatible and ready for use by target computer 110. In one example embodiment, target computer 110 may send a request to conditioning device 115 to access the files stored in removable device 105, and will then be redirected by conditioning device 115 to the emulated drive containing the conditioned files.

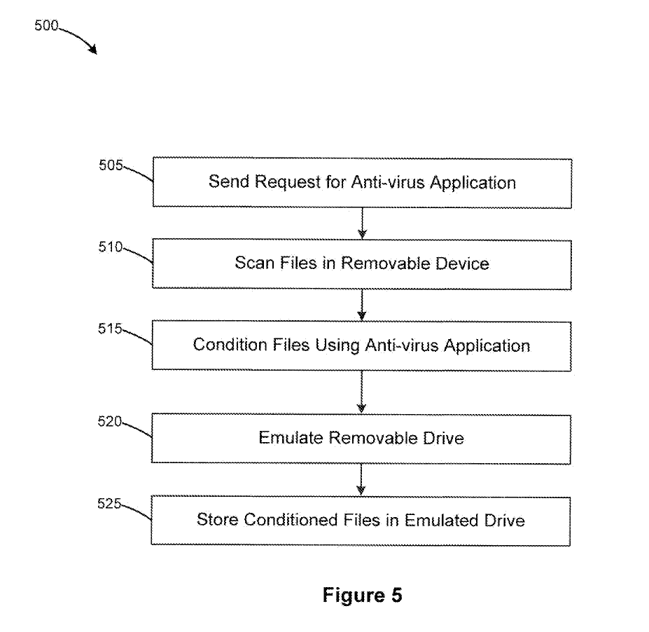

FIG. 5 is a flowchart showing an example method 500 of conditioning files stored in removable device 105 by scanning and cleaning the stored files from viruses or any malicious software using an antivirus application. Method 500 may be performed as an additional conditioning method before, after, or during performing method 400. Method 500 may be performed using one or more computer instructions stored in conditioning device 115.

One or more parameters may be set up by conditioning device 115 to be used for filtering the one or more files to remove malicious software. At 505, a request for an application to scan the files stored in removable device 105 may be sent from conditioning device 115 to remote computer 235 through network 255. In an alternative example embodiment, the request may be sent from conditioning device 115 to target computer 110. In another example embodiment, target computer 110 may be queried or interrogated to determine if an application for scanning, cleaning and repairing the files is available on target computer 110 before sending a request for the application from remote computer 235. Retrieving the application may include a user manually choosing the application for scanning the files and cleaning them from malicious software through the use of input peripheral device 240 and monitor 245 connected to conditioning device 115, or through input and output means of imaging device 300 if conditioning device 115 is embedded in imaging device 300. Retrieving the application may also include retrieving the application from external computer system 250 connected with conditioning device 115 directly or through imaging device 300.

The application may be an anti-virus application or any type of application that is capable of scanning for malicious software from files and cleaning the files from the malicious software, thereby making the files substantially safe for sharing from removable device 105 to target computer 110. The application may also perform a scan for corrupt files and repair and/or recover the corrupt files. Corrupt files may have unintended changes performed on the original data and, as a result, cannot be opened by appropriate applications due to an error or “corruption” that occurred during at least one of the writing, reading, storage, transmission, or processing of the files.

At 510, the requested application then scans the files stored in removable device 105 to check for malicious software and/or corruption in each of the files. In one example embodiment, the scanning and the cleaning and/or repairing of the stored files using the requested application may be performed while the application is running on target computer 110, or on remote computer 235 from which the application was requested.

At 520, removable device 105 is emulated by conditioning device 115 to duplicate or emulate functions of removable device 105 right in conditioning device 115 so that the emulated drive closely resembles the behavior of removable device 105. In an alternative example embodiment, emulating the removable device 105 may be performed using 420 of method 400, and method 500 may directly proceed to 510.

If a file is found to be corrupt or infected with malicious software, the file may be repaired and/or cleaned by the requested application, and the repaired and/or cleaned file stored in the emulated drive (at 525).

If the file is identified to be irreparable, the file may be deleted from the removable device 105. Alternatively, the file may be left stored in removable device 105 but no copy of the irreparable file is stored in the emulated drive that can be accessed by a user of target computer 110.

Target computer 110 is given access to the conditioned files through the emulated drive in conditioning device 115 instead of directly accessing removable device 105 to prevent contamination of either or both removable device 105 and target computer 110 if at least one of the devices still contains malicious software. Accessing the emulated drive to retrieve the conditioned files also allows target computer 110 to access files that are determined to be safe and ready for use by target computer 110. In one example embodiment, target computer 110 may send a request to conditioning device 115 to access the files stored in removable device 105, and will then be redirected by conditioning device 115 to the emulated drive containing the conditioned files.

It will be appreciated that not all of the actions described in FIGS. 4 and 5 needs to be performed in accordance with the embodiments of the disclosure and/or additional actions may be performed in accordance with other embodiments of the disclosure.

The foregoing illustrates various aspects of the invention. It is not intended to be exhaustive. Rather, it is chosen to provide the best illustration of the principles of the invention and its practical application to enable one of ordinary skill in the art to utilize the invention, including its various modifications that naturally follow. All modifications and variations are contemplated within the scope of the invention as determined by the appended claims. Relatively apparent modifications include combining one or more features of various embodiments with features of other embodiments.

1. A method for sharing one or more files from a removable medium to a target computer, comprising:
sending a request for an application for converting the one or more files to a format compatible for use in the target computer;
using the application, converting the files into the compatible format;
emulating a file system, the emulated file system corresponding to the removable medium;
storing the converted files in the emulated file system; and
providing the target computer access to the converted files through the emulated file system.

2. The method of claim 1, wherein the sending of the request for the application includes requesting for the application from a remote computer through a network.

3. The method of claim 1, further comprising communicating to the target computer a request for an antivirus application for use in scanning the one or more files.

4. The method of claim 3, further comprising scanning and cleaning the one or more files from viruses using the antivirus application.

5. The method of claim 4, wherein the scanning and the cleaning of the one or more files are performed while the antivirus application is running on the target computer.

6. The method of claim 1, further comprising repairing a corrupt file from the one or more files using the application.

7. An imaging device, comprising:
a peripheral interface for communicatively connecting to a removable device;
a file system emulated to appear as the removable device to the imaging device; and
a conditioning device communicatively connected to the removable device through the peripheral interface and is operative to:
access an antivirus application from a remote system communicatively connected with the imaging device to scan the one or more files in the removable device;
store the scanned one or more files in the emulated file system; and
allow the imaging device to access the scanned one or more files of the removable device through the emulated file system.

8. The imaging device of claim 7, wherein the conditioning device is further operative to access an application from the remote system to convert the one or more files into a format compatible for use with the imaging device.

9. The imaging device of claim 7, wherein the controller is further operative to repair a corrupt file from the one or more files and store the repaired file in the emulated file system.

10. The imaging device of claim 7, wherein the peripheral interface is operative to receive a request from the imaging device to connect with the removable device.

11. The imaging device of claim 7, wherein the conditioning device is further operative to determine if the imaging device contains an application that can be used to process the one or more files.

12. The imaging device of claim 7, further comprising a network interface operative to connect the imaging device with the remote system through a network connection.

13. The imaging device of claim 7, further comprising an input peripheral interface for receiving user preferences relating to the one or more files in the removable device.

14. The imaging device of claim 7, wherein the conditioning device is further operative to interrogate the remote system for the antivirus application.

15. A conditioning device communicatively connected to a removable media device, the conditioning device having a non-transitory computer-readable storage medium containing computer executable instructions to:
receive a request from a host computing device to access one or more files stored in the removable media device;
set up one or more parameters to be used for reformatting the one or more files stored in the removable media device to a format for immediate use by the host computing device upon connecting to the removable media device;
reformat the one or more files in the removable media device using the one or more parameters;
emulate a file system to correspond to the removable media device;
store the reformatted one or more files in the emulated file system; and
allow the host computing device to access the reformatted one or more files through the emulated file system.

16. The conditioning device of claim 15, wherein the instruction to set up the one or more parameters includes an instruction to access an application for reformatting the one or more files.

17. The conditioning device of claim 16, wherein the instruction to access the application includes an instruction to interrogate a remote computer connected to the removable media device through a network for the application.

18. The conditioning device of claim 16, wherein the instruction to access the application includes an instruction to interrogate the host computing device for the application.

19. The conditioning device of claim 15, wherein the instruction to reformat the one or more files includes an instruction to scan the one or more files for viruses.

20. The conditioning device of claim 15, wherein the instruction to reformat the one or more files includes an instruction to repair a corrupt file from the one or more files and store the repaired file in the emulated file system.
